(19) United States
(12) Patent Application Publication
(10) Pub. No.: US 2007/0279006 A1
(43) Pub. Date: Dec. 6, 2007

(54) Method of testing electrochemical cells

(76) Inventors: Esther S. Takeuchi, East Amherst, NY (US); Hong Gan, Williamsville, NY (US); Steven Davis, Williamsville, NY (US); Joseph Lehnes, Williamsville, NY (US)

Correspondence Address: Michael F. Scalise;Wilson Greatbatch Technologies, Inc., 9645 Wehrle Drive, Clarence, NY, 14031, US

(21) Appl. No.: 11/032,428

(22) Filed: Jan. 10, 2005

Related U.S. Application Data
(60) Provisional application No. 60/535,256, filed on Jan. 9, 2004.

(51) Int. Cl. H02J 7/00; G01N 27/416

(52) U.S. Cl. 320/135; 324/426

(57) ABSTRACT

A method for determining whether a cell will experience unacceptable voltage delay later in its discharge life before it is incorporated into a device as its power source is described. As is standard practice, the cell is first subjected to a constant resistance load discharge followed by extended elevated temperature storage and an acceptance pulse discharge. This typically depletes the cell of about 1% to 3% of its theoretical discharge capacity. According to the present invention, the cell is again stored at an elevated temperature for an extended period followed by a second pulse discharge. This second pulse discharge is to ferret out any cell that may end up experiencing unacceptable voltage delay later in its discharge life.

### CROSS REFERENCE TO RELATED APPLICATION

This application claims priority from U.S. provisional application Ser. No. 60/535,256, filed Jan. 9, 2004.

### BACKGROUND OF THE INVENTION

1. Field of the Invention

The present invention generally relates to an alkali metal electrochemical cell, and more particularly, to an electrochemical cell suitable for current pulse discharge applications. More particularly, the present invention is directed to identifying cells that will experience unacceptable voltage delay later in their discharge life before they are incorporated into a device as its power source. This method is particularly useful with an alkali metal/solid cathode cell, and specifically a lithium/silver vanadium oxide cell (Li/SVO).

2. Prior Art

Efforts have been made to develop a test administered at the beginning of a cell's life that will be indicative of its long-term performance. Such a test would be useful as a means of screening out poor performers, problem solve root causes to various performance issues, and determine and identify the impact of certain factors or changes in components and manufacturing processes. Conventional methods include subjecting a cell to elevated temperature storage or an accelerated discharge procedure, or comparing individual cell burn-in data to the general population. An exemplary burn-in consists of subjecting a Li/SVO cell to a 2.49 kΩ load for 17 to 24 hours at up to 80° C., followed by an open circuit rest period and a single pulse train at about one week after elevated temperature conditioning. This burn-in discharge typically depletes the cell of about 0.5% to 5% of its total capacity.

The problem is that the initial conditioning procedure may not be sufficient to identify a cell containing un-reacted starting materials in its cathode, contamination from foreign bodies, and the like. Having un-reacted starting materials in the cathode can manifest itself in the form of unacceptable voltage delay after the cell has been incorporated into a device, such as the power source for an implantable medical device. Contamination can also have undesirable consequences later in a cell's discharge life. Therefore, there is a need for a test that is relatively easy to administer and evaluate and that differentiates between cells prone to experiencing unacceptable voltage delay, and the like, and those that will not.

### SUMMARY OF THE INVENTION

Voltage delay and irreversible Rdc growth are phenomena typically exhibited in an alkali metal/solid cathode cell, and particularly a Li/SVO cell, that has been depleted of about 25% to 70% of its capacity and is being subjected to current pulse discharge applications. The problem is that this is after the cell has been incorporated into a device as its power source. Therefore, it is desirable to have a test that is performed early in a cell's discharge life to determine if the cell will experience unacceptable levels of voltage delay later.

The voltage response of a cell that does not exhibit voltage delay during the application of a short duration pulse or pulse train has distinct features. First, the cell potential decreases throughout the application of the pulse until it reaches a minimum at the end of the pulse, and second, the minimum potential of the first pulse in a series of pulses is higher than the minimum potential of the last pulse. FIG. 1 is a graph showing an illustrative discharge curve 10 as a typical or “ideal” response of a cell during the application of a series of pulses as a pulse train that does not exhibit voltage delay.

The voltage response of a cell that exhibits voltage delay during the application of a short duration pulse or during a pulse train can take one or both of two forms. One is that the leading edge potential of the first pulse is lower than the end edge potential of the first pulse. In other words, the voltage of the cell at the instant the first pulse is applied is lower than the voltage of the cell immediately before the first pulse is removed. The second form of voltage delay is that the minimum potential of the first pulse is lower than the minimum potential of the last pulse when a series of pulses have been applied. FIG. 2 is a graph showing an illustrative discharge curve 12 as the voltage response of a cell that exhibits both forms of voltage delay.

The initial drop in cell potential during the application of a short duration pulse reflects the resistance of the cell, i.e., the resistance due to the cathode, anode, electrolyte, surface films and polarization. In the absence of voltage delay, the resistance due to passivated films on the anode and/or cathode is negligible. In other words, the drop in potential between the background voltage and the lowest voltage under pulse discharge conditions, excluding voltage delay, is an indication of the conductivity of the cell, i.e., the conductivity of the cathode, anode, electrolyte, and surface films, while the gradual decrease in cell potential during the application of the pulse train is due to the polarization of the electrodes and the electrolyte.

In that respect, the present invention provides a means of determining whether or not a cell will experience unacceptable voltage delay later in its discharge life before it is incorporated into a device as its power source. As is standard practice, the cell is first subjected to a constant resistance load discharge followed by extended elevated temperature storage and an acceptance pulse discharge. This pre-discharge burn-in typically depletes the cell of about 1% to 3% of its theoretical discharge capacity. Up to this, the discharge protocol is standard procedure. According to the present invention, however, the cell is again stored at an elevated temperature for an extended period followed by a second pulse discharge. This second pulse discharge is to ferret out any cell that may end up experiencing unacceptable voltage delay later in its discharge life.

### BRIEF DESCRIPTION OF THE DRAWINGS

FIG. 1 is a graph showing an illustrative pulse discharge curve 10 of an exemplary electrochemical cell that does not exhibit voltage delay.

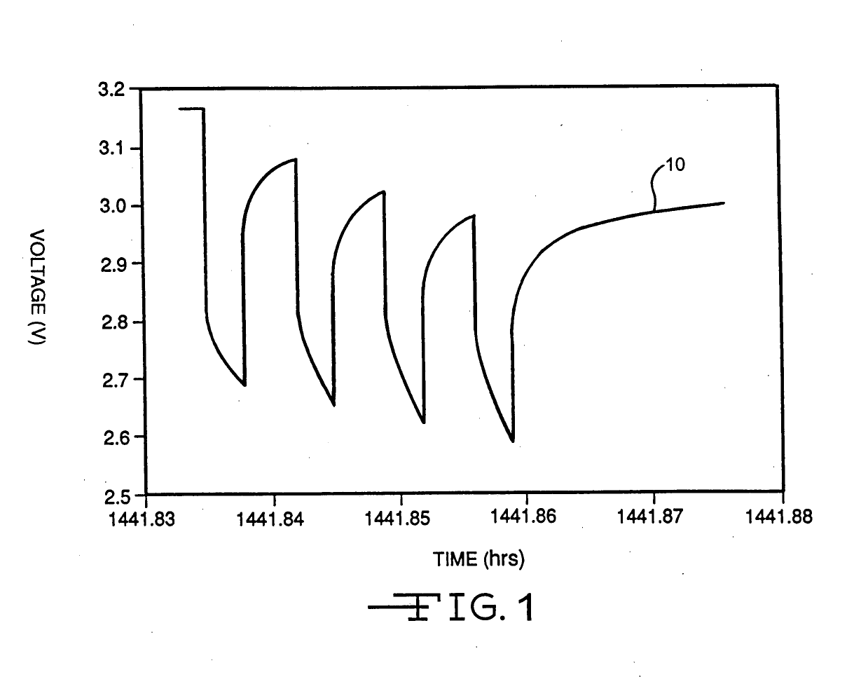

FIG. 2 is a graph showing an illustrative pulse discharge curve 12 of an exemplary electrochemical cell that exhibits voltage delay.

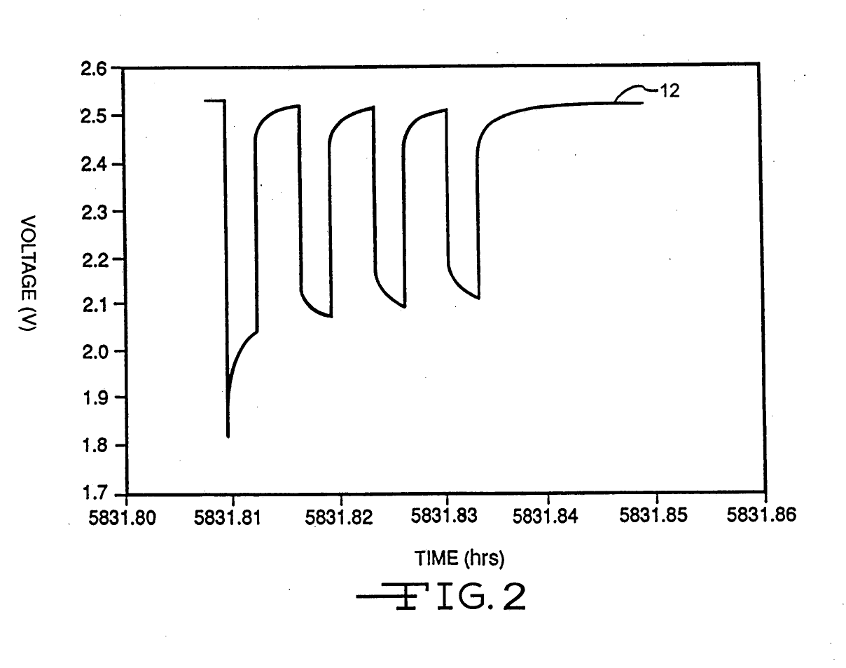

FIG. 3 is a block diagram and flow chart illustrating the steps involved in manufacturing a cathode component from a freestanding sheet of cathode active material for use in an electrochemical cell.

### DETAILED DESCRIPTION OF THE PREFERRED EMBODIMENTS

An electrochemical cell according to the present invention includes an anode electrode selected from Group IA of the Periodic Table of Elements, including lithium, sodium, potassium, etc., and their alloys and intermetallic compounds including, for example Li—Si, Li—B and Li—Si—B alloys and intermetallic compounds. The preferred anode comprises lithium, and the more preferred anode comprises a lithium alloy, the preferred lithium alloy being lithium-aluminum with the aluminum comprising from between about 0% to about 50% by weight of the alloy. The greater the amounts of aluminum present by weight in the alloy, however, the lower the energy density of the cell.

The form of the anode may vary, but preferably it is a thin metal sheet or foil of the anode metal pressed or rolled on a metallic anode current collector, i.e., preferably comprising nickel, to form an anode component. The anode current collector has an extended tab or lead contacted by a weld to a cell case of conductive metal in a case-negative electrical configuration. Alternatively, the anode may be formed in some other geometry, such as a bobbin shape, cylinder or pellet to allow an alternate low surface cell design.

The cathode comprises a material capable of conversion of ions that migrate from the anode to the cathode into atomic or molecular forms. A suitable cathode active material is a mixed metal oxide formed by chemical addition, reaction or otherwise intimate contact or by a thermal spray coating process of various metal sulfides, metal oxides or metal oxide/elemental metal combinations.

In that respect, it is desirable for the cathode active material to be a single phase mixed metal oxide. A preferred single phase mixed metal oxide begins by thoroughly mixing silver nitrate with vanadium pentoxide. This mixture is first heated to about 2° C. to about 40° C. above the mixture's decomposition temperature. Preferably, the mixture is heated to about 300° C., which is about 20° C. above the decomposition temperature of the mixture, but below the decomposition temperature of the silver nitrate constituent alone. The mixture of starting materials is held at this temperature for about 5 hours to about 16 hours, or until the mixture has completely decomposed. After thoroughly grinding the resulting decomposed admixture, it is heated to a temperature of about 50° C. to about 250° C. above the decomposition temperature of the admixture for about 12 to 48 hours, or to about 490° C. to about 520° C. for about 48 hours for the silver nitrate and vanadium pentoxide admixture. This preparation technique is thoroughly discussed in U.S. Pat. No. 6,566,007 to Takeuchi et al., which is assigned to the assignee of the present invention and incorporated herein by reference.

One preferred low surface area, single phase mixed metal oxide substantially comprises an active material having the general formula SMₓV₂O_{y} wherein SM is a metal selected from Groups IB to VIIB and VIII of the Periodic Table of Elements and wherein x is about 0.30 to 2.0 and y is about 4.5 to 6.0 in the general formula. By way of illustration, and in no way intended to be limiting, an exemplary cathode active material comprises silver vanadium oxide having the general formula AgₓV₂O_{y} in any one of its many phases, i.e. β-phase silver vanadium oxide having in the general formula x=0.35 and y=5.18, γ-phase silver vanadium oxide having in the general formula x=0.74 and y=5.37 and ε-phase silver vanadium oxide having in the general formula x=1.0 and y=5.5, the latter phase being most preferred.

The low surface area, single phase mixed metal oxide displays increased capacity and decreased voltage delay in comparison to a mixed phase metal oxide such as silver vanadium oxide prepared using a decomposition synthesis from AgNO₃ and V₂O₅ starting materials (U.S. Pat. No. 4,391,729 to Liang et al.) and from Ag₂O and V₂O₅ by a chemical addition reaction (U.S. Pat. No. 5,498,494 to Takeuchi et al.). These patents are assigned to the assignee of the present invention and incorporated herein by reference. This means that a low surface area, single-phase SVO material is particularly well suited for pulse discharge applications.

Another preferred composite transition metal oxide cathode material includes V₂O_{z} wherein z≦5 combined with Ag₂O having silver in either the silver(II), silver(I) or silver(0) oxidation state and CuO with copper in either the copper(II), copper (I) or copper (0) oxidation state to provide the mixed metal oxide having the general formula CuₓAg_{y}V₂O_{z}, (CSVO). Thus, the composite cathode active material may be described as a metal oxide-metal oxide-metal oxide, a metal-metal oxide-metal oxide; or a metal-metal-metal oxide and the range of material compositions found for CuₓAg_{y}V₂O_{z} is preferably about 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO varies depending on whether the cathode material is prepared in an oxidizing atmosphere such as air or oxygen, or in an inert atmosphere such as argon, nitrogen and helium. For a more detailed description of this cathode active material, reference is made to U.S. Pat. No. 5,472,810 to Takeuchi et al. and U.S. Pat. No. 5,516,340 to Takeuchi et al., both of which are assigned to the assignee of the present invention and incorporated herein by reference.

Other suitable cathode materials include copper vanadium oxide, manganese dioxide, titanium disulfide, copper oxide, copper sulfide, iron sulfide, and iron disulfide. Carbon and fluorinated carbon are also useful cathode active materials. The solid cathode exhibits excellent thermal stability and is generally safer and less reactive than a non-solid cathode.

Such cathode active materials are formed into a cathode electrode with the aid of a binder material. Suitable binders are powdered fluoro-polymers; more preferably powdered polytetrafluoroethylene or powdered polyvinylidene fluoride. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 1 to 5 weight percent, a conductive diluent present at about 1 to 5 weight percent and about 90 to 98 weight percent of the cathode active material.

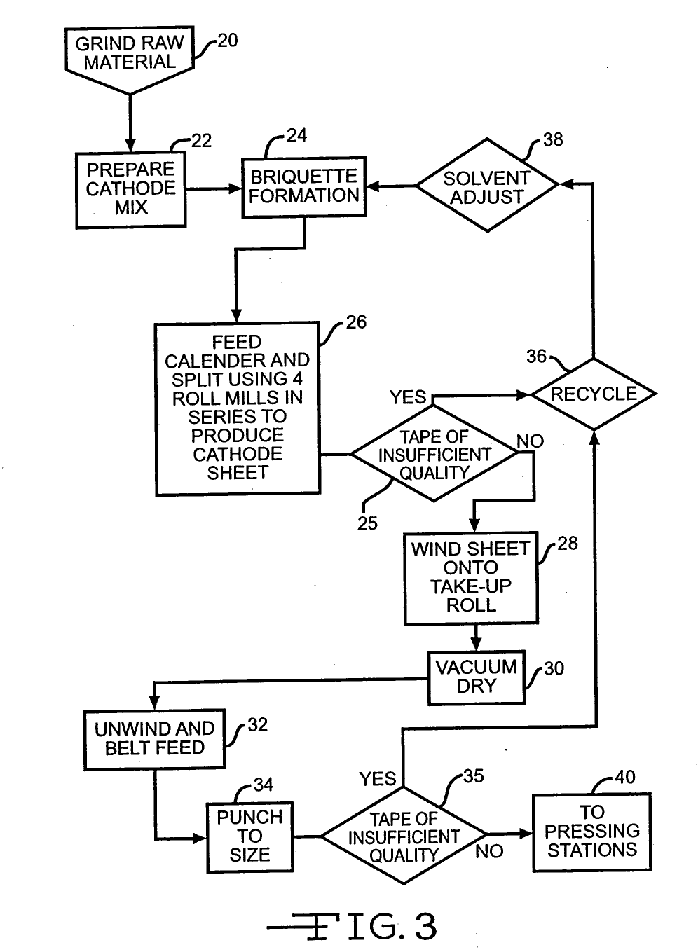

The cathode electrode is formed either by rolling, spreading or pressing the cathode active mixture onto a suitable current collector. Another preferred method for building a cathode electrode is to press a freestanding sheet of the active mixture to a current collector as illustrated in the block diagram flow chart of FIG. 3. This method begins by taking any one of the above cathode active materials, and preferably the low surface area, single phase mixed metal oxide material made according to the previously discussed U.S. Pat. No. 6,566,007 to Takeuchi et al., and adjusting its particle size to a useful range in attrition or grinding step 20. A ball mill or vertical ball mill is preferred and typical grinding times range from between about 10 to 15 minutes. The finely divided cathode material is preferably mixed with one of the above-described conductive diluents and binder materials to form a depolarizer cathode admixture in the step designated 22. Preferably, the admixture comprises about 3 weight percent of the conductive diluents and about 3 weight percent of the binder material. This is typically done in a solvent of either water or an inert organic medium such as mineral spirits. The mixing process provides for fibrillation of the fluoro-resin to ensure material integrity. In some cases, no electronic conductor material or binder is required and the percent cathode active material is preferably held between about 80 percent to about 99 percent. After mixing sufficiently to ensure homogeneity in the admixture, the cathode admixture is removed from the mixer as a paste.

The admixture paste is then fed into a series of roll mills that compact the cathode material into a thin sheet having a tape form, or the cathode admixture first is run through a briquette mill in the step designated 24. In the latter case, the cathode admixture is formed into small pellets that are then fed into the roll mills.

Typically, the compacting step 26 is performed by two to four calendar mills that serve to press the admixture between rotating rollers to provide a freestanding sheet of the cathode material as a continuous tape. The cathode tape preferably has a thickness in the range of from about 0.004 inches to about 0.020 inches. The outer edges of the tape leaving the rollers are trimmed and wound up on a take-up reel, as indicated at 28, to form a roll of the cathode material that is subsequently subjected to a drying step 30 under vacuum conditions. The drying step removes any residual solvent and/or water from the cathode material. Alternatively, the process includes drop wise addition of liquid electrolyte into the cathode mixture prior to rolling to enhance the performance and rate capacity of an assembled electrochemical cell incorporating the cathode material.

After drying, the cathode material is unwound and fed on a conveyor belt, as shown at 32, and moved to a punching machine. The punching operation 34 forms the continuous tape of cathode material into any dimension needed for preparation of the cathode component.

As shown in FIG. 3, the method contains several feedback loops that serve to recycle the cathode active material should the quality control not be up to an acceptable level. This contributes to the process yield, as very little cathode material is lost to waste. After the cathode admixture is pressed during step 26 by the series of calendar mills, if, as represented by conditional box 25, the resulting tape is too thin or otherwise of insufficient quality, the tape is sent to a recycler, indicated as step 36 that reintroduces the cathode material into the feed line entering the calendar mills. If needed, the solvent concentration is adjusted during step 38 as needed, to provide a more uniform consistency to the cathode admixture paste for rolling into the cathode tape. This first recycle step 36 is also useful for reintroducing trimmings and similar leftover cathode material back into the feed line entering the calendar mills.

A second recycle loop, indicated by conditional box 35, removes the cathode material from the process after the punching operation 34 and feeds back into the calendar mills 26 through the recycler indicated in step 36 and the briquette mill in step 24, if that latter step is included in the process, as previously discussed. Again, the solvent concentration is adjusted during step 38 to produce a paste that is suitable for rolling into a tape of uniform cross-sectional thickness.

As previously discussed, upon completion of the drying step 30, the tape of cathode material is sent to the punching operation 34. The punching operation serves to cut the sheet material into cathode plates having a variety of shapes including strips, half-round shapes, rectangular shapes, oblong pieces, or others, that are moved during step 40 to a pressing station for fabrication of the cathode electrode. For a more detailed description of the pressing operation, reference is made to U.S. Pat. Nos. 5,435,874 and 5,571,640, both to Takeuchi et al.

Cathodes prepared as described above may be in the form of one or more plates operatively associated with at least one or more plates of anode material. Alternatively, the cathode may be in the form of a strip wound with a corresponding strip of anode material in a structure similar to a “jellyroll”.

The cell of the present invention includes a separator to provide physical separation between the anode and cathode active electrodes. The separator is of electrically insulative material to prevent an internal electrical short circuit between the electrodes, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include non-woven glass, polypropylene, polyethylene, glass fiber material, ceramics, a polytetrafluorethylene membrane commercially available under the designations ZITEX (Chemplast Inc.), a polypropylene membrane commercially available under the designation CELGARD (Celanese Plastic Company Inc.) and DEXIGLAS (C. H. Dexter, Div., Dexter Corp.).

The form of the separator typically is a sheet that is placed between the anode and cathode electrodes and in a manner preventing physical contact between them. Such is the case when the anode is folded in a serpentine-like structure with a plurality of cathode plates disposed intermediate the anode folds and received in a cell casing or when the electrode combination is rolled or otherwise formed into a cylindrical “jellyroll” or flat folded configuration.

The electrochemical cell of the present invention further includes a nonaqueous, ionically conductive electrolyte that serves as a medium for migration of ions between the anode and the cathode during the electrochemical reactions of the cell. The electrochemical reaction at the cathode involves conversion of ions that migrate from the anode to the cathode in atomic or molecular forms. A suitable electrolyte has an inorganic, ionically conductive salt dissolved in a nonaqueous solvent. More preferably, the electrolyte includes an ionizable alkali metal salt dissolved in a mixture of aprotic organic solvents comprising a low viscosity solvent and a high permittivity solvent. The inorganic, ionically conductive salt serves as the vehicle for migration of the anode ions to intercalate or react with the cathode active materials. Preferably, the ion forming alkali metal salt is similar to the alkali metal comprising the anode. In the case of an anode comprising lithium, the electrolyte salt is selected from LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Low viscosity solvents useful with the present invention include esters, linear and cyclic ethers and dialkyl carbonates such as tetrahydrofuran, methyl acetate, diglyme, trigylme, tetragylme, dimethyl carbonate, 1,2-dimethoxyethane, 1,2-diethoxyethane, 1-ethoxy,2-methoxyethane, ethyl methyl carbonate, methyl propyl carbonate, ethyl propyl carbonate, diethyl carbonate, dipropyl carbonate, and mixtures thereof. High permittivity solvents include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone, N-methyl-pyrrolidinone, and mixtures thereof. In the present invention, the preferred anode active material is lithium metal and the preferred electrolyte is 0.8M to 1.5 M LiAsF₆ or LiPF₆ dissolved in a 50:50 mixture, by volume, of propylene carbonate and 1,2-dimethoxyethane.

The assembly of the cell described herein is preferably in the form of a wound element cell. That is, the fabricated cathode, anode and separator are wound together in a “jellyroll” type configuration or “wound element cell stack” such that the anode is on the outside of the roll to make electrical contact with the cell case in a case-negative configuration. Using top and bottom insulators, the wound cell stack is inserted into a metallic case of a suitable size dimension. The metallic case may comprise materials such as stainless steel, mild steel, nickel-plated mild steel, titanium or aluminum, but not limited thereto, so long as the metallic material is compatible for use with components of the cell.

The cell header comprises a metallic disc-shaped or rectangular-shaped body with a first hole to accommodate a glass-to-metal seal/terminal pin feedthrough and a second hole for electrolyte filling. The glass used is of a corrosion resistant type having from between about 0% to about 50% by weight silicon such as CABAL 12, TA 23, FUSITE 425 or FUSITE 435. The positive terminal pin feedthrough preferably comprises titanium although molybdenum, aluminum, nickel alloy, or stainless steel can also be used. The cell header comprises elements having compatibility with the other components of the electrochemical cell and is resistant to corrosion. The cathode lead is welded to the positive terminal pin in the glass-to-metal seal and the header is welded to the case containing the electrode stack. The cell is thereafter filled with the electrolyte solution described hereinabove and hermetically sealed such as by close-welding a stainless steel disc or ball over the fill hole, but not limited thereto. This above assembly describes a case-negative cell that is the preferred construction of the exemplary cell of the present invention. As is well known to those skilled in the art, the electrochemical system of the present invention can also be constructed in a case-positive configuration.

Cells built according to the present invention are particularly well suited for powering implantable medical devices such as cardiac pacemakers, defibrillators, neuro-stimulators and drug pumps. For example, an implantable cardiac defibrillator is a device that requires a power source for a generally medium rate, constant resistance load component provided by circuits performing functions such as the heart sensing and pacing functions. This is a medical device monitoring function that requires electrical current of about 1 microampere to about 100 milliamperes. From time-to-time, the cardiac defibrillator may require a generally high rate, pulse discharge load component that occurs, for example, during charging of a capacitor in the defibrillator for the purpose of delivering an electrical shock to the heart to treat tachyarrhythmias, the irregular, rapid heartbeats that can be fatal if left uncorrected. This medical device operating function requires a significantly greater electrical current than the monitoring function of about 1 ampere to about 4 amperes. Lower pulse voltages caused by voltage delay, even if only temporary, are undesirable since they can cause circuit failure in the powered device especially during the medical device operating function, and effectively result in shorter cell life. Rdc build-up also reduces the life of an electrochemical cell by lowering the pulse voltage during high rate discharge. Accordingly, it is important that the cell experience as little voltage delay as possible, particularly during the medical device operating function.

In order to ferret out those cells that will experience unacceptable voltage delay, a cell built according to the present invention is first subjected to a constant resistive load at an elevated temperature. This initial pre-discharge period is preferably done soon after the cell is built and at least before it is used as a device power source. The discharge load is typically from about 1 kΩ to about 14 kΩ or about 0.186 mA/cm² to about 0.004 mA/cm² at a temperature of ambient to about 80° C. A typical discharge is under a 7.5 kΩ at 37° C. This pre-discharge period is referred to as burn-in and depletes the cell of about 0.4% to about 2.4% of its theoretical discharge capacity.

Following burn-in, the cell is stored at ambient to about 80° C. for up to about one month, preferably at 37° C. for about one week, followed by an acceptance pulse discharge. The term “pulse” means a short burst of electrical current of significantly greater amplitude than that of a pre-pulse current or open circuit voltage immediately prior to the pulse. A pulse train consists of at least one pulse of electrical current. The pulse is designed to deliver energy, power or current. If the pulse train consists of more than one pulse, they are delivered in relatively short succession with or without open circuit rest between the pulses. An exemplary pulse train may consist of one to four 5 to 20-second pulses (23.2 mA/cm²) with about a 10 to 30 second rest, preferably about 15 second rest, between each pulse. A typically used range of current densities for cells powering implantable medical devices is from about 2 mA/cm² to about 50 mA/cm², and more preferably from about 18 mA/cm² to about 35 mA/cm². Typically, a 10 second pulse is suitable for medical implantable applications. However, it could be significantly shorter or longer depending on the specific cell design and chemistry and the associated device energy requirements. Current densities are based on square centimeters of the cathode electrode. The acceptance pulse train depletes the cell of about 0.1% to about 2.6% of its theoretical capacity. This means that the combined burn-in and acceptance pulse deplete the cell of about 0.5% to about 5% of its capacity.

Up to this point, the discharge protocol is standard prior art procedure. According to the present invention, the alkali metal/solid cathode cell, and particularly the Li/SVO cell, is then stored at ambient to about 80° C. for up to about one month, preferably at 37° C. for about one week, followed by a second discharge of at least one pulse of electrical current. The reason for this second pulse discharge is to ferret out any cell that may end up experiencing unacceptable voltage delay before it is incorporated into a device as its power source. It is believed that this high temperature storage after the standard prior art discharge procedure reacts any un-reacted high voltage silver and vanadium starting materials within the cathode material. It also accelerates undesirable side reactions caused by minute quantities of contaminants that would not normally manifest themselves until later in the cell's discharge life and possibly identifies a cell in which the separator has been breached. Then, if the cell has un-reacted starting materials, unexpected contamination or possibly a breached separator, and the like, a subsequent pulse discharge is enough to determine this. Although more than one pulse can be administered, a single pulse discharge is preferred so that no more energy is removed than necessary to accomplish the objective of the present invention. The pulse is preferably from about 2 mA/cm² to about 50 mA/cm², depending on the size of the cell. For example, a ten-second 23-mA/cm² pulse is typical.

Then, if the minimum voltage during this second discharge of at least one pulse of electrical current is above a minimum threshold, the cell will not experience unacceptable voltage delay later in its discharge life. The minimum voltage threshold is greater than about 2.2 volts, more preferably greater than about 2.3 volts, and most preferably greater than about 2.4 volts.

The following examples describe the manner and process of an electrochemical cell according to the present invention, and set forth the best mode contemplated by the inventors of carrying out the invention.

### EXAMPLE I

Twenty-nine Li/SVO cells were constructed and designated as Group I. These cells were subjected to a constant resistive load of 7.5 kΩ at 37° C. during an initial pre-discharge period. The pre-discharge period is referred to as burn-in and depleted the cells of approximately 2% of their theoretical capacity. Following burn-in, the cells were stored at 37° C. for one week followed by an acceptance pulse train consisting of four ten second 23-mA/cm² pulses (separated by 15 seconds under background load). Up to this point, the discharge protocol is a standard prior art procedure. According to the present invention, the cells were then stored for one more week at 37° C. followed by a single ten-second 23-mA/cm²-pulse discharge.

The Group I cells displayed an average voltage delay of 0.003 volts after the standard acceptance pulse train discharge. After the additional one week storage at 37° C. followed by the single ten-second two-Ampere pulse, the Group I cells displayed an average voltage delay of 0.010 volts. As shown in Table 1, this calculates to an average 0.007-volt increase in voltage delay comparing the standard method to that of the present invention. Assuming a minimum acceptable pulse voltage of 2.4 V, none of the Group I cells was rejected after the standard acceptance pulse testing as well as after the extended storage period and the final single pulse discharge according to the present invention.

TABLE 1

| | Observed Voltage Delay (V) | | % Rejected at 2.4 V | |
|---|---|---|---|---|
| Group | Prior Art | Present Method | Prior Art | Present Method |
| I | 0.003 | 0.010 | 0 | 0 |
| II | 0.004 | 0.041 | 0 | 0 |
| III | 0.002 | 0.204 | 0 | 80 |
| IV | 0.011 | 0.215 | 0 | 100 |

### EXAMPLE II

A group of three lithium silver vanadium oxide cells was constructed in an identical manner as those in Example I with the exception that a second lot of silver vanadium oxide cathode material was utilized. These cells, designated as Group II, were subjected to the standard resistive run down of approximately 2% total capacity and an acceptance pulse train consisting of four ten second 23-mA/cm² pulses (separated by 15 seconds under background load). According to the present invention, they were then stored at 37° C. followed by a single ten-second 23-mA/cm² -pulse discharge.

The Group II cells displayed an average voltage delay of 0.004 volts after the standard acceptance pulse train discharge. After the additional one week storage at 37° C. followed by the single ten-second two-Ampere pulse, the Group II cells displayed an average voltage delay of 0.041 volts. As shown in Table 1, this calculates to an average 0.037-volt voltage delay increase comparing the standard method to that of the present invention. Again, assuming a minimum acceptable pulse voltage of 2.4 V, none of the Group II cells was rejected after the standard acceptance pulse testing as well as after the extended storage period and the final single pulse discharge according to the present invention.

### EXAMPLE III

A group of five lithium silver vanadium oxide cells was constructed in an identical manner as those in Example I with the exception that a third lot of silver vanadium oxide cathode material was utilized. These cells, designated as Group III, were subjected to the standard resistive run down of approximately 2% total capacity and an acceptance pulse train consisting of four ten second 23-mA/cm² pulses (separated by 15 seconds under background load). According to the present invention, they were then stored at 37° C. followed by a single ten-second 23-mA/cm² -pulse discharge.

The Group III cells displayed an average voltage delay of 0.002 volts after the standard acceptance pulse train discharge. After the additional one week storage at 37° C. followed by the single ten-second two-Ampere pulse, the Group III cells displayed an average voltage delay of 0.204 volts. As shown in Table 1, this calculates to an average 0.202-volt voltage delay increase comparing the standard method to that of the present invention. Again, assuming a minimum acceptable pulse voltage of 2.4 V, none of the Group III cells was rejected after the standard acceptance pulse testing. After the extended storage period and the final single pulse discharge according to the present invention, however, four out of five or 80% of the Group III cells were rejected as not acceptable for use in powering an implantable medical device.

### EXAMPLE IV

A group of three lithium silver vanadium oxide cells was constructed in an identical manner as those in Example I with the exception that a fourth lot of silver vanadium oxide cathode material was utilized. These cells, designated as Group IV, were subjected to the standard resistive run down of approximately 2% total capacity and an acceptance pulse train consisting of four ten second 23-mA/cm² pulses (separated by 15 seconds under background load). According to the present invention, they were then stored at 37° C. followed by a single ten-second 23-mA/cm²-pulse discharge.

The Group IV cells displayed an average voltage delay of 0.011 volts after the standard acceptance pulse train discharge. After the additional one week storage at 37° C. followed by the single ten-second two-Ampere pulse, the Group IV cells displayed an average voltage delay of 0.215 volts. As shown in Table 1, this calculates to an average 0.204-volt voltage delay increase comparing the standard method to that of the present invention. Again, assuming a minimum acceptable pulse voltage of 2.4 V, none of the Group IV cells was rejected after the standard acceptance pulse testing. After the extended storage period and the final single pulse discharge according to the present invention, however, 100% of the Group IV cells were rejected as not acceptable for use in powdering an implantable medical device.

Thus, it is apparent that if an alkali metal/solid cathode cell, and specifically a lithium/silver vanadium oxide cell, is only subjected to the standard acceptance pulse testing, it may be deemed acceptable for incorporation into an implantable medical device when, in fact, it is not. This can be problematic. In addition to subjecting the patient to an earlier than expected surgery, a significant portion of the useful life of a relatively expensive medical device may be wasted. On the other hand, subjecting an alkali metal/solid cathode, and in particular a Li/SVO cell, to an additional elevated temperature storage period followed by a single pulse discharge according to the present invention will identify those cells that are likely to develop unacceptable voltage delay later in their discharge lives before they are used to power a medical device implanted in a patient.

It is appreciated that various modifications to the inventive concepts described herein may be apparent to those of ordinary skill in the art without departing from the spirit and scope of the present invention as defined by the appended claims.

1. A method for determining whether a cell will experience unacceptable voltage delay, comprising the steps of:
a) providing the cell comprising a lithium-containing anode and a cathode comprising an active material selected from the group consisting of silver vanadium oxide, copper silver vanadium oxide, copper vanadium oxide, manganese dioxide, titanium disulfide, copper oxide, copper sulfide, iron sulfide, iron disulfide, carbon, fluorinated carbon, and mixtures thereof activated with a nonaqueous electrolyte;
b) pulse discharging the cell a first time substantially at the beginning of its discharge life to deliver at least one first pulse at a current density of from about 2 mA/cm² to about 50 mA/cm² based on square centimeters of the cathode to thereby deplete the cell of up to about 5% of its theoretical capacity;
c) storing the cell at a temperature from about 37° C. to about 80° C.;
d) pulse discharging the cell a second time to deliver at least one second pulse at a current density of from about 2 mA/cm² to about 50 mA/cm² based on square centimeters of the cathode; and
e) determining that there will not be any significant voltage delay if a minimum cell potential during the at least one second current pulse is greater than about 2.4 volts at a current density of about 23 mA/cm².

2. The method of claim 1 wherein discharging the cell the first time includes subjecting the cell to a constant resistive load of from about 0.004 mA/cm² to about 0.186 mA/cm² based on square centimeters of the cathode.

3. The method of claim 2 including discharging the cell through the constant resistive load at a temperature of from ambient to about 80° C.

4. The method of claim 2 wherein discharging the cell through the constant resistive load depletes the cell of from about 0.4% to about 2.4% of its theoretical discharge capacity.

5. (canceled)

6. The method of claim 1 wherein pulse discharging the cell the first time depletes the cell of from about 0.1% to about 2.6% of its theoretical discharge capacity.

7. The method of claim 1 wherein discharging the cell the first time includes delivering one to four 5 to 20-second about 2 mA/cm² to about 50 mA/cm² pulses with about a 10 to 30 second rest between each pulse.

8. The method of claim 1 wherein discharging the cell the first time includes subjecting the cell to a constant resistive load to thereby deplete the cell of about 2% of its theoretical capacity followed by storage at from about 37° C. to about 80° C. for up to about one month followed by delivering the at least one first pulse of electrical current.

9. The method of claim 1 wherein discharging the cell the first time includes depleting the cell of from about 0.5% to about 5% of its theoretical capacity.

10. The method of claim 1 wherein storing the cell between discharging it the first time and the second time is done at from about 37° C. to about 80° C. for up to about one month.

11.-13. (canceled)

14. A method for determining whether a cell will experience unacceptable voltage delay, comprising the steps of:
a) providing the cell comprising a lithium-containing anode and a cathode comprising an active material selected from the group consisting of silver vanadium oxide, copper silver vanadium oxide, copper vanadium oxide, manganese dioxide, titanium disulfide, copper oxide, copper sulfide, iron sulfide, iron disulfide, carbon, fluorinated carbon, and mixtures thereof activated with a nonaqueous electrolyte;
b) discharging the cell a first time substantially at the beginning of its discharge life by subjecting it to a constant resistive load followed by storage at from ambient to about 80° C. followed by delivering at least one first pulse at a current density of from about 2 mA/cm² to about 50 mA/cm² based on square centimeters of the cathode to thereby deplete the cell of up to about 5% of its theoretical capacity;
c) storing the cell at from about 37° C. to about 80° C. for up to about one month;
d) pulse discharging the cell a second time to deliver at least one second pulse at a current density of from about 2 m/cm² to about 50 mA/cm² based on square centimeters of the cathode; and
e) determining that there will not be any significant voltage delay if a minimum cell potential during the at least one second current pulse is greater than about 2.2 volts at a current density of 23 mA/cm².

15. A method for determining whether a cell will experience unacceptable voltage delay, comprising the steps of:
a) providing the cell comprising a lithium-containing anode and a cathode comprising an active material of silver vanadium oxide activated with a nonaqueous electrolyte;
b) discharging the cell a first time substantially at the beginning of its discharge life by subjecting it to a constant resistive load of from about 0.004 mA/cm² to about 0.186 mA/cm² followed by storage at from ambient to about 80° C. followed by delivering at least one first pulse at a current density of from about 2 mA/cm² to about 50 mA/cm² based on square centimeters of the cathode to thereby deplete the cell of up to about 5% of its theoretical capacity;
c) storing the cell at from about 37° C. to about 80° C. for up to about one month;
d) pulse discharging the cell a second time to deliver at least one second pulse at a current density of from about 2 mA/cm² to about 50 mA/cm² based on square centimeters of the cathode; and
e) determining that there will not be any significant voltage delay if a minimum cell potential during the at least one second current pulse is greater than about 2.4 volts at a current density of about 23 mA/cm².
